(19) United States
(12) Patent Application Publication
(10) Pub. No.: US 2014/0129743 A1
(43) Pub. Date: May 8, 2014

(54) INPUT/OUTPUT INSTRUMENT, SYSTEM, AND DEVICE

(71) Applicant: AZBIL CORPORATION, Tokyo (JP)

(72) Inventor: Toshiya MORITA, Tokyo (JP)

(73) Assignee: AZBIL CORPORATION, Tokyo (JP)

(21) Appl. No.: 14/074,538

(22) Filed: Nov. 7, 2013

(30) Foreign Application Priority Data
Nov. 8, 2012 (JP) 2012-246422

(51) Int. Cl. G06F 3/00

(52) U.S. Cl. CPC G06F 3/00
USPC 710/36

(57) ABSTRACT

A plurality of devices for sending and receiving a signal relating to a process are capable of being connected to an input/output instrument. The input/output instrument includes an operating signal receiving portion that receives, from a first device that is one of the plurality of the devices, an operating signal corresponding to a specific operating instruction, a selecting portion that selects, based on the operating signal that has been received by the operating signal receiving portion, any single second device, from among the devices connected to a local input/output instrument, other than the first device that is the source that sent the operating signal, and a remote device information sending portion that sends as remote device information to the first device that was the source that sent the operating signal, information pertaining to the second device that was selected by the selecting portion.

### CROSS REFERENCE TO RELATED APPLICATION

This application claims priority under 35 U.S.C. §119 to Japanese Patent Application No. 2012-246422, filed on Nov. 8, 2012, the entire content of which being hereby incorporated herein by reference.

### FIELD OF TECHNOLOGY

The present invention relates to an input/output instrument, system, and device.

### BACKGROUND

In the field of manufacturing process control, various types of devices having communication functions (for example, sensors, valves, and the like) are installed in the plants, to control the various manufacturing processes in the plants through reading into a system signals that are transmitted from the devices. As systems that control manufacturing processes there are those that control, for example, the degree of opening of valves based on flow rates, temperatures, pressures, and the like, read in from sensors. For example, Japanese Unexamined Patent Application Publication No. 2012-123446 (“the JP '446”) describes a technology for displaying, on a displaying portion of a device (a field instrument), displaying information for other devices in addition to display information, such as measurement values, control values, and the like, for a local device.

The device of the JP '446, mentioned above, merely displays, on a displaying portion, display information that is sent from a higher-level device or another device in the system, and does not go so far as to enable requesting, from the side of the device that is to display information, display information from another device. Consequently, the display information of the other device cannot be referenced by querying a higher-level device, or the like.

The present invention is to solve the problem area in the conventional technology, set forth above, and an aspect thereof is to provide an input/output instrument, system, and device wherein it is possible to send display information to another device in response to a request from a given device.

### SUMMARY

The input/output instrument according to the present invention is an input/output instrument to which a plurality of devices for sending and receiving a signal relating to a process are capable of being connected. The input/output instrument includes an operating signal receiving portion that receives, from a first device that is one of the plurality of the devices, an operating signal corresponding to a specific operating instruction, a selecting portion that slectes, based on the operating signal that has been received by the operating signal receiving portion, any single second device, from among the devices connected to the local input/output instrument, other than the first device that is the source that sent the operating signal, and a remote device information sending portion that sends as remote device information to the first device that was the source that sent the operating signal, information pertaining to the second device that was selected by the selecting portion.

When such a structure is used and a user inputs a desired operating instruction into a first device that is connected to an input/output instrument, the input/output instrument, based on the operating signal corresponding to that operating instruction, can select a second device that is connected to the input/output instrument, and send, to the first device, information pertaining to the selected second device. Doing so makes it possible to display on the first device information pertaining to the second device, desired by the user.

A system according to the present invention includes a device that sends and receives a signal relating to a process and an input/output instrument to which a plurality of the devices are capable of being connected. The device includes an operation inputting portion that inputs a specific operating instruction, an operating signal transmitting portion that transmits, to the input/output instrument, an operating signal corresponding to the operating instruction inputted from the operation inputting portion, a remote device information receiving portion that receives, from the input/output instrument, remote device information that is information pertaining to another device that is connected to the input/output instrument that has been selected based on the operating signal, and a displaying portion that displays the remote device information that has been received from the remote device information receiving portion. The input/output instrument includes an operating signal receiving portion that receives the operating signal from the first device that is one of the plurality of the devices, a selecting portion that selects, based on the operating signal that has been received by the operating signal receiving portion, any single second device, from among the devices connected to the local input/output instrument, other than the first device that is the source that sent the operating signal, and a remote device information sending portion that sends as remote device information to the first device that was the source that sent the operating signal, information pertaining to the second device that was selected by the selecting portion.

When such a structure is used and a user inputs a desired operating instruction into a first device that is connected to an input/output instrument, the input/output instrument, based on the operating signal corresponding to that operating instruction, can select a second device that is connected to the input/output instrument, and send, to the first device, information pertaining to the selected second device, making it possible to display on the displaying portion of the first device, information pertaining to a second device desired by a user.

The input/output instrument may include a plurality of connecting slots that connect the devices through communication cables, and the selecting portion may select the second device through scanning the connecting slots in a direction that increases specific information or a direction that decreases specific information, in order to specify the connecting slot, with each operating signal that is received by the operating signal receiving portion.

This makes it possible to display, sequentially, on the displaying portion, information pertaining to a second device that is connected to the input/output instrument, through repetitively inputting operating instructions using the first device.

An input/output apparatus that includes a plurality of the input/output instruments may further be provided wherein the operating signal includes a first operating signal that directs the sequential selection of a connecting slot within a single input/output instrument and a second signal that directs the sequential selection of an input/output instrument within a single input/output apparatus. The selecting portion, upon reception of the first signal by the operating signal inputting portion, each time the first signal is received, scans the connecting slots in either the direction with which the specific information increases or the direction with which the specific information decreases, in order to specify the connecting slot to select the second device, and upon reception of the second signal by the operating signal inputting portion, each time the second signal is received, scans the input/output instruments in either the direction with which the specific information increases or the direction with which the specific information decreases, in order to specify the input/output instrument to select the second device.

This makes it possible to display sequentially, on the displaying portion, information pertaining to a second device that is connected to another input/output instrument, in addition to information pertaining to a second device that is connected to the same input/output instrument as the first device, through inputting a combination with a different type of operating instruction, using the first device.

The present invention makes it possible to provide an input/output instrument, system, and device wherein it is possible to send display information to another device in response to a request from a given device.

### BRIEF DESCRIPTIONS OF THE DRAWINGS

FIG. 1 is a block diagram illustrating a structure for a process controlling system including an input/output instrument and device according to an example.

FIG. 2 is a block diagram illustrating a structure of an instrument that is compatible with HART communication and a HART-I/O instrument.

FIG. 3 is a schematic diagram for explaining and operating procedure when displaying device information of another HART communication-compatible instrument in the example.

FIG. 4 is a schematic diagram for explaining and operating procedure when displaying device information of another HART communication-compatible instrument in a modified example.

### DETAILED DESCRIPTION

Examples according to the present invention will be explained below in reference to the drawings. However, any one of the examples explained below is no more than an illustration, and does not exclude various modifications and applications to technologies not explicated below. That is, the present invention can be embodied in a variety of modified forms, in the scope that does not deviate from the spirit and intent thereof.

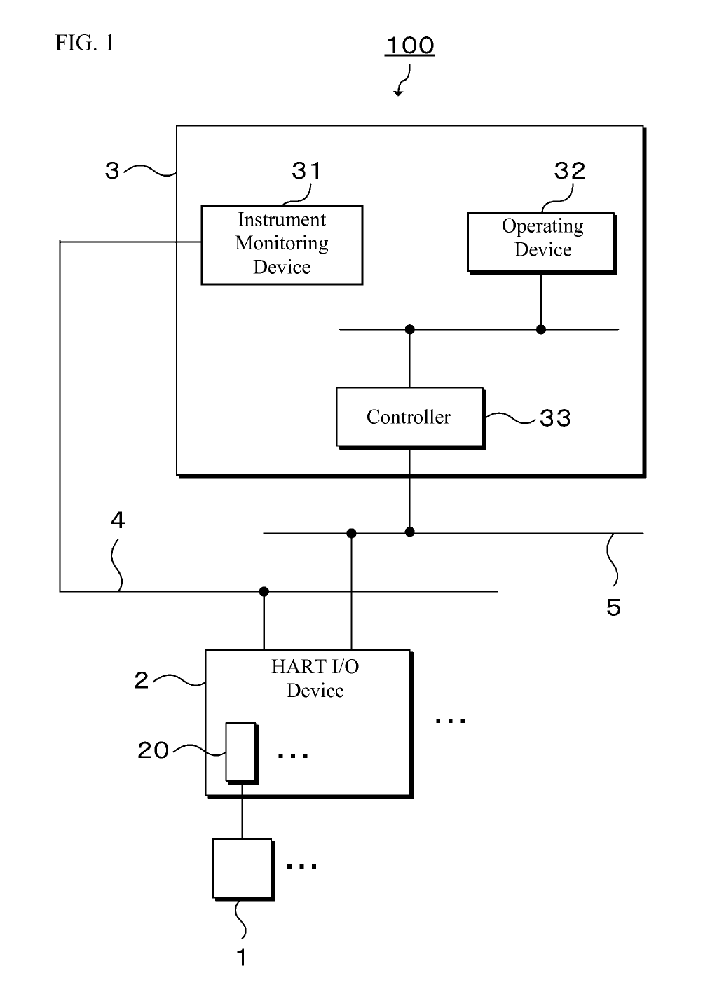

First the structure of the process controlling system that includes an input/output instrument and device in an example will be explained in reference to FIG. 1. As illustrated in FIG. 1, the process controlling system 100 is provided with, for example, a HART (Highway Addressable Remote Transducer) communication-compatible instrument 1, a Hart-I/O device 2 that includes a plurality of a Hart-I/O instruments 20 that are input/output instruments having a HART communication functions, and a higher-level device 3. The higher-level device 3 includes an instrument monitoring device 31, an operating device 32, and a controller 33.

The instrument monitoring device 31 functions as a monitoring system for monitoring the status, and the like, of the HART communication-compatible instrument 1, and the operating device 32 and controller 33 function as a control system for controlling the manufacturing processes.

The HART I/O device 2 and the instrument monitoring device 31 are connected through a communication cable 4 of, for example, the Ethernet standard, where the HART I/O device 2 and the controller 33 are connected by, for example, a communication bus 5.

The HART communication-compatible instrument 1 may be a device of a variety of types equipped within a plant. The HART communication-compatible instrument 1 may be a transmitting device for transmitting a flow rate, pressure, temperature, or the like, a positioner for changing/detecting the degree of opening of a valve such as a flow rate controlling valve or a pressure controlling valve, or an actuator for actuating a pump, a fan, or the like.

The HART communication-compatible instrument 1 is provided with a HART communication function, to input and output HART communication signals. The HART communication signals are signals produced by superimposing an AC signal wherein logic of a digital signal is converted through assignment to frequencies of 2200 Hz and 1200 Hz, onto a DC signal of between 4 and 20 mA.

The aforementioned DC signal of between 4 and 20 mA is a signal indicating one variable that is set for each HART communication-compatible instrument 1. The variable value is data pertaining to a process, such as a measurement value such as, for example, a flow rate, a pressure, or a temperature, or a control value such as a degree of valve opening. The digital signal is a signal corresponding to various types of data that can be collected within the HART communication-compatible instrument 1. The various data may be, for example, process information within the HART communication-compatible instrument 1, or diagnostic information for hardware incorporated within the HART communication-compatible instrument 1. Note that measurement values and control values of the HART communication-compatible device may also be included in the various types of data.

The HART I/O device 2 is an input/output apparatus able to contain a plurality of HART I/O instruments 20. The HART I/O instruments 20 are input/output instruments that have a plurality of connecting slots, where a HART communication-compatible instrument 1 is connected to an individual slot. The HART I/O instrument 20 sends and receives HART communication signals between respective HART communication-compatible instruments 1 and sends and receives digital signals to and from an instrument monitoring device 31.

In the process control system 100 according to the present example, each of the individual HART I/O devices 2, the HART I/O instruments 20, and the HART communication-compatible instrument 1, which each exist in a plurality, are controlled as described below. A different file number is assigned to each individual HART I/O device 2. A different card number is assigned to each individual HART I/O instrument 20 that is contained in a single HART I/O device 2. A different slot number is assigned to each individual connecting slot that is provided in a single HART I/O instrument 20. This makes it possible to specify, through a file number, a card number, and a slot number, a connection address, within the system, for a HART communication-compatible instrument 1.

In the present example, information that is indicated by that file number, card number, and slot number is used as connection address information for the HART communication-compatible instrument 1. For example, if the communication address information is “5.4.8,” then that communication address information indicates the connection address of a HART communication-compatible instrument 1 that is connected to the connecting slot for which the slot number is “8,” in a HART I/O instrument 20 for which the card number is “4,” in a HART I/O device 2 for which the file number is 5.

The instrument monitoring device 31 periodically sends a request signal to each HART communication-compatible instrument 1 through the HART I/O instrument 20, and receives response signals in response to the request signals. Based on the response signals received, the instrument monitoring device 31 evaluates the state of execution of the processes of the HART communication-compatible instruments 1, failure states of hardware incorporated into the HART communication-compatible instruments 1, required timing for maintenance and repairs of the HART communication-compatible instruments 1, and so forth. The instrument monitoring device 31 displays the evaluation results on a monitor (not shown). Doing so enables the administrator to ascertain the status of the HART communication-compatible instruments 1.

The controller 33 controls the status of execution of the manufacturing process through controlling the HART communication-compatible device 1. For example, the controller 33 controls another HART communication-compatible instrument 1 based on, for example, a measured value for a flow rate or pressure received from a given HART communication-compatible instrument 1, to adjust the degree of opening, or the like, of a valve.

The operating device 32 displays the operating detail of the HART communication-compatible devices 1 on a monitor screen (not shown), based on the 4 to 20 mA DC signals received from the controller 33. Doing so enables the operator to ascertain the input/output status of the HART communication-compatible instruments 1. The operating device 32 controls the operating status of the controller 33 in accordance with operating instructions from the operator. The operating detail of the operating status may be, for example, an operation for starting-up a device or an operation for shutting-down the controller 33.

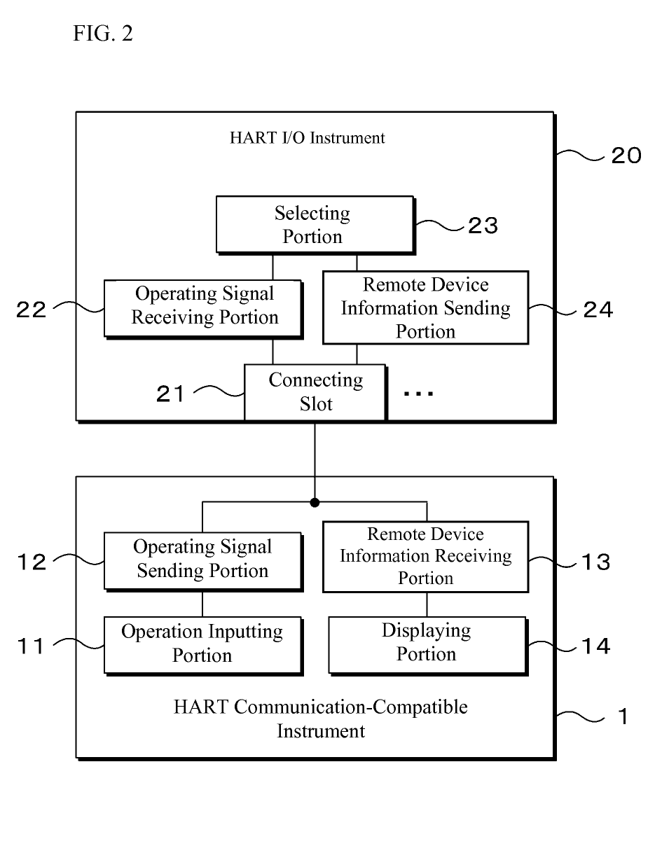

The functional structure of a HART communication-compatible instrument 1 and a HART I/O instrument 20 will be explained in reference to FIG. 2. As illustrated in FIG. 2, the HART communication-compatible instrument 1 has, for example, an operation inputting portion 11, an operating signal sending portion 12, a remote device information receiving portion 13, and a displaying portion 14.

The operation inputting portion 11 is input keys for inputting specific operating instructions to the HART I/O instrument 20. As an operating instruction, there is, for example, an instruction for causing the detection of the connecting slot to which another HART communication-compatible instrument 1 is connected, from among the connecting slots that are provided in the HART I/O instrument 20 to which the local device is connected.

In the present example, as input keys, a “↓” key for indicating that a connecting slot in the downward direction from the connecting slot of the current location (the direction wherein the slot numbers are increasing) is to be detected, and a “↑” key for indicating that a connecting slot in the upward direction from the connecting slot of the current location (the direction wherein the slot numbers are decreasing) is to be detected, for example, are used.

The operating signal sending portion 12 sends, to the HART I/O instrument 20, an operating signal corresponding to the operating instruction that has been inputted from the operation inputting portion 11.

The remote device information receiving portion 13 receives, from the HART I/O instrument 20, remote device information that is information pertaining to the remote HART communication-compatible instrument 1 that is connected to the HART I/O instrument 20 that is the connection address of the local device 1.

The displaying portion 14 displays, on a display, local device information that is information pertaining to the local device 1 and remote device information that has been received through the remote device information receiving portion 13 (which will be termed “device information,” below, when there is no need to differentiate between the two types of information).

As device information there is, for example, connection address information for a HART communication-compatible instrument 1, identification information for the HART communication-compatible instrument 1, display information that includes variable values such as measurement values and control values, and the like, of the HART communication-compatible instrument 1. In the present example, for purposes of illustration, the connection address information that is expressed by the file number, the card number, and the slot number, the tag name that is set for identifying the HART communication-compatible instrument 1 on the higher-level device 3 side, and a first variable value (primary value) and a second variable value (secondary value), which are typical display information for the HART communication-compatible instrument 1, are used as device information.

The connection address information for the HART communication-compatible instrument 1 are controlled by the HART I/O instrument 20 and the higher-level device 3. When the HART communication-compatible instrument 1 initially displays the device information, the connection address information for the local device is obtained from the HART I/O instrument 20.

The tag name information for the HART communication-compatible instrument 1 is set initially in each individual HART communication-compatible instrument 1. The tag name that is set initially uses, for example, the HART communication “UniversalCommand20: Read Long Tag,” and is sent from each individual HART communication-compatible instrument 1 to the HART I/O instrument 20 and the higher-level device 3, to be controlled by the HART I/O instrument 20 and the higher-level device 3.

The first variable value and second variable value for a HART communication-compatible instrument 1 are variable values such as measurement values, control values, or the like, for the HART communication-compatible instrument 1. The first variable value and second variable value use, for example, the HART communication “UniversalCommand9: Read Device Variable with Status,” and are received periodically by the HART I/O instrument 20 from each individual HART communication-compatible instrument 1 and transmitted to the higher-level device 3, and the respective most recent values thereof are also recorded in the HART I/O instrument 20.

The HART I/O instrument 20, illustrated in FIG. 2, has, for example, connecting slots 21, an operating signal receiving portion 22, a selecting portion 23, and a remote device information sending portion 24.

The connecting slots 21 are slots for connecting HART communication-compatible instruments 1 to the HART I/O instrument 20. A plurality of connecting slots 21 is provided in a single HART I/O instrument 20. In the present example, for purposes of illustration a case will be explained wherein 16 connecting slots 21 are provided, but there is no limitation to the number of slots, but rather this number may be set arbitrarily. Each connecting slot 21 is assigned a slot number for identifying the connecting slot 21.

The operating signal receiving portion 22 receives an operating signal that is sent from a HART communication-compatible instrument 1.

The selecting portion 23, based on an operating signal that has been received from the operating signal receiving portion 22, selects one of the HART communication-compatible instruments 1, from among the HART communication-compatible instruments 1 that are connected to the local HART I/O instrument 20, to be the source of device information that is to be displayed by the device that had sent the operating signal. This is explained in detail below.

When the operating signal is a signal corresponding to a keypress of the “↓” key, the selecting portion 23, each time this operating signal is received, scans the connecting slots 21 in the direction of increasing slot numbers, from the number of the slot that is currently subject to display, to select, as the source device for device information to be displayed, the HART communication-compatible instrument 1 that is connected to the closest connecting slot 21.

When the operating signal is a signal corresponding to a keypress of the “↑” key, the selecting portion 23, each time this operating signal is received, scans the connecting slots 21 in the direction of decreasing slot numbers, to select, as the source device for device information to be displayed, the HART communication-compatible instrument 1 that is connected to the closest connecting slot 21.

The remote device information sending portion 24 sends, to the HART communication-compatible instrument 1 that was the source that sent the operating signal, the device information of the HART communication-compatible instrument 1 that has been selected by the selecting portion 23.

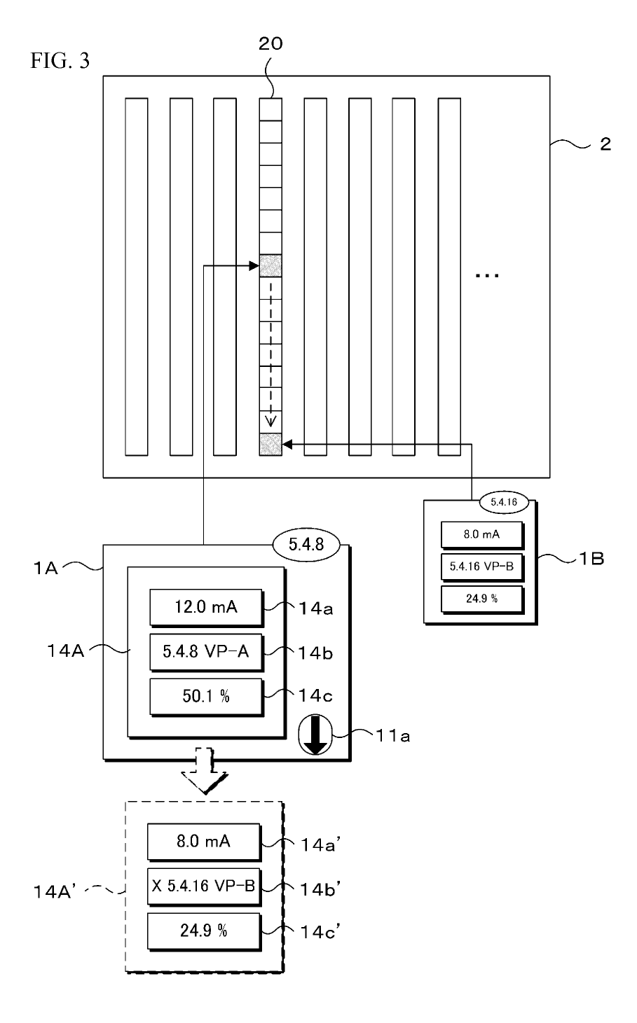

The operating procedure when the “↓” key 11a has been pressed on a HART communication-compatible instrument 1A (a first device) to display device information of a remote HART communication-compatible instrument 1B (a second device) will be explained in reference to FIG. 3.

This explanation is based on the premise that the only devices having HART communication functions that are connected to the HART I/O instrument 20 within the HART I/O device 2 are the HART communication-compatible instrument 1A and HART communication-compatible instrument 1B. Moreover, it is assumed that the file number of the HART I/O device 2 is “5,” the card number of the HART I/O instrument 20 is “4,” the slot number of the connecting slot to which the HART communication-compatible instrument 1A is connected is “8,” and the slot number of the connecting slot to which the HART communication-compatible instrument 1B is connected is “16.”

Moreover, as the default information, device information for the HART communication-compatible instrument 1A is displayed on the display 14A of the HART communication-compatible instrument 1A. Specifically, “12.0 mA,” which indicates the first variable value for the HART communication-compatible instrument 1A, is displayed at 14a. “5.4.8,” which is the connection address information for the HART communication-compatible instrument 1A, and “VP-A,” which is the tag name for the HART communication-compatible instrument 1A, are displayed at 14b. This “VP-A” indicates that the HART communication-compatible instrument 1A is a valve positioner, and the identification code thereof is “A.” “50.1%,” which indicates the second variable value for the HART communication-compatible instrument 1A, is displayed at 14c.

Device information for the HART communication-compatible instrument 1B that is the same as that which is described above for the HART communication-compatible instrument 1A is displayed as the default information on the display of the HART communication-compatible instrument 1B.

First the “↓” key 11a that is included in the operation inputting portion 11 in the HART communication-compatible instrument 1A is pressed. The fact that the “1” key 11a has been pressed may be reported through, for example, the HART I/O instrument 20 using the HART communication “UniversalCommand48: Read Additional Device Status” to obtain the status from the HART communication-compatible instrument 1 periodically.

Following this, the selecting portion 23 of the HART I/O instrument 20 that has detected the keypress of the “↓” key 11a scans the connecting slots in the direction of increasing slot numbers, from the slot number “8,” of the slot to which the HART communication-compatible instrument 1A is connected, to select the HART communication-compatible instrument 1B that is connected to the connecting slot with the slot number “16,” as the nearest connecting slot.

Following this, the remote device information sending portion 24 of the HART I/O instrument 20 sends, as remote device information, the device information of the HART communication-compatible instrument 1B, selected by the selecting portion 23 to the HART communication-compatible instrument 1A.

Following this, the displaying portion 14 of the HART communication-compatible instrument 1A displays, on a display 14A′, the display information for the HART communication-compatible instrument 1B.

The result is that “8.0 mA,” which indicates the first variable value of the HART communication-compatible instrument 1B is displayed at 14a′ of the display 14A′ of the HART communication-compatible instrument 1A, “5.4.16,” which is the connection address information for the HART communication-compatible instrument 1B, and “VP-B,” which is the tag name for the HART communication-compatible instrument 1B, are displayed at 14b′, and “24.9%,” which indicates the second variable value of the HART communication-compatible instrument 1B is displayed at 14c′. The X that is displayed at the beginning of 14b′ is a mark indicating that the device information that is displayed currently on the display 14A′ is remote device information.

As described above, in the process controlling system 100 according to the present example, a user can operate an input key, to input a desired operating instruction, on the HART communication-compatible instrument 1A that is connected to the HART I/O instrument 20, to cause the HART I/O instrument 20, based on the operating signal corresponding to that operating instruction, to select a remote HART communication-compatible instrument 1B that is connected to the HART I/O instrument 20, to transmit, to the HART communication-compatible instrument 1A, device information for the selected remote HART communication-compatible instrument 1B. Doing so makes it possible for a user to display, on the display of the HART communication-compatible instrument 1A, device information for a desired remote HART communication-compatible instrument.

Moreover, in the HART communication-compatible instrument 1A, repetitively pressing the “↓ close vote key and the “↑” key makes it possible to display sequentially, on the display, information regarding other HART communication-compatible instruments that are connected to the HART I/O instrument 20.

### Modified Example

While in the example set forth above the device information for the HART communication-compatible instruments 1 that are connected to the same HART I/O instrument 20 is displayed through operating the “↑” key and the “↓” key, there is no limitation that thereto. For example, the device information for the HART communication-compatible instruments 1 that are connected to another HART I/O instrument 20 within the same HART I/O device 2 may be displayed by operating the “→” key and the “←” key.

In a modified example, in addition to the “↑” key and the “↓” key used in the example set forth above, a “→” key, for an instruction to detect a HART I/O instrument to the right of the HART I/O instrument of the current location (that is, in the direction of increasing card numbers), and a “←” key, for an instruction to detect a HART I/O instrument to the left of the HART I/O instrument of the current location (that is, in the direction of decreasing card numbers) are also used.

Consequently, the operating signals in the present modified example include a first signal that indicates the sequential selection of a connecting slot 21 within a single HART I/O instrument 20, and a second signal that indicates the sequential selection of HART I/O instruments 20 within a single HART I/O device 2. Specifically, the first signal is a signal corresponding to a keypress of the “↑” key or the “↓” key, and the second signal is a signal corresponding to a keypress of the “→” key or the “←” key.

When the first signal is received by the operating signal receiving portion 22, the selecting portion 23, each time this first signal is received, scans the connecting slots 21 in the direction of increasing slot numbers or the direction of decreasing slot numbers, from the number of the slot that is currently subject to display, to select, as the source device for device information to be displayed, the HART communication-compatible instrument 1 that is connected to the closest connecting slot 21.

When the second signal is received by the operating signal receiving portion 22, the selecting portion 23, each time this second signal is received, scans the HART I/O instruments 20 in the direction of increasing card numbers or the direction of decreasing card numbers, from the number of the card that is currently subjected to display to select, as the source device for device information to be displayed, one of the HART communication-compatible instruments 1 that is connected to the closest HART I/O instrument 20.

Here, when the nearest HART I/O instrument has been detected based on the second signal, the selecting portion 23 may scan the connecting slots 21 in either the direction of increasing slot numbers or the direction of decreasing slot numbers from the starting (smallest) slot number within the detected HART I/O instrument to select, as the source device for the device information to be displayed, the HART communication-compatible instrument 1 that is connected to the nearest connecting slot 21. Moreover, when the nearest HART I/O instrument 20 has been detected based on the second signal, the connecting slots 21 may be scanned in either the direction of increasing slot numbers or the direction of decreasing slot numbers from the slot number within the detected HART I/O instrument 20 that is identical to the slot number that is positioned within the original HART I/O instrument 20, to select, as the source device for the device information to be displayed, the HART communication-compatible instrument 1 that is connected to the nearest connecting slot 21.

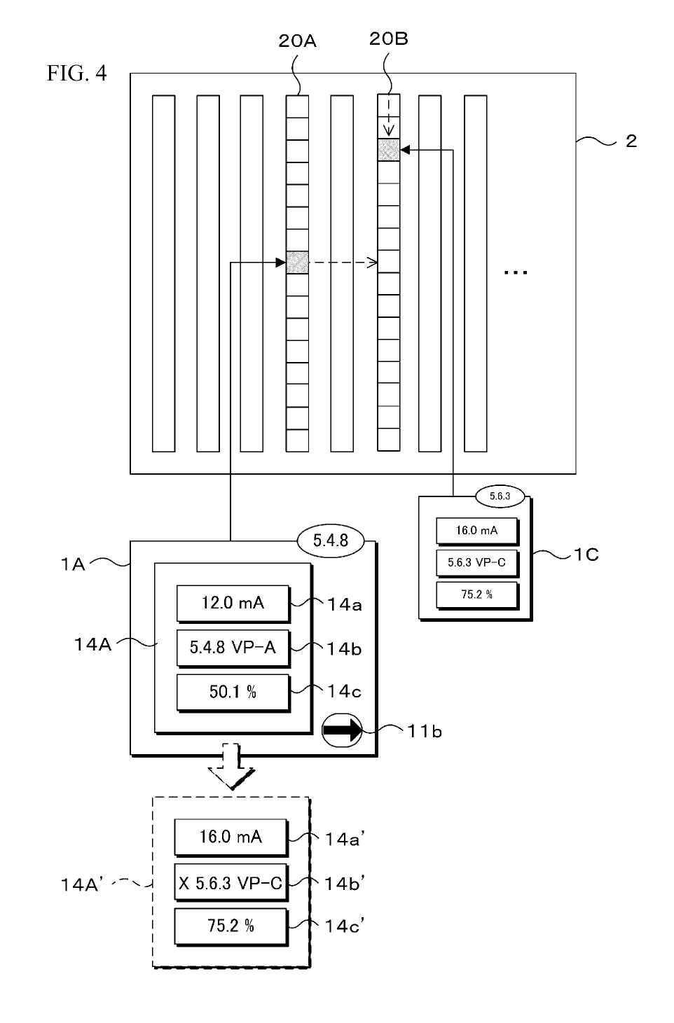

The operating procedure when the “→” key 11b has been pressed on a HART communication-compatible instrument 1A (a first device) according to the modified example to display device information of a remote HART communication-compatible instrument 1C (a second device) will be explained in reference to FIG. 4.

This explanation is based on the premise that devices having HART communication functions are connected to only a HART I/O instrument 20A and a HART I/O instrument 20B within the HART I/O device 2. Moreover, it is assumed that the file number of the HART I/O device 2 is “5,” the card number of the HART I/O instrument 20A is “4,” the card number of the HART I/O instrument 20B is “6,” the slot number of the connecting slot to which the HART communication-compatible instrument 1A is connected is “8,” and the slot number of the connecting slot to which the HART communication-compatible instrument 1C is connected is “3.”

Device information for the HART communication-compatible instrument 1A (the same device information as in FIG. 3) is displayed as the default information on the display 14A of the HART communication-compatible instrument 1A and device information for the HART communication-compatible instrument 1C is displayed as the default information on the display of the HART communication-compatible instrument 1C.

First the “→” key 11b that is included in the operation inputting portion 11 in the HART communication-compatible instrument 1A is pressed.

Following this, the selecting portion 23 of the HART I/O instrument 20A that has detected the keypress of the “→” key 11b scans the HART I/O instruments in the direction of increasing card numbers, from the card number “4,” of the card to which the HART communication-compatible instrument 1A is connected, to select, from the HART I/O instruments, the nearest HART I/O instrument 20B to which a HART communication-compatible instrument is connected.

Following this, the selecting portion 23 of the HART I/O instrument 20A scans the connecting slots in the direction of increasing slot numbers, from the first slot number of the HART I/O instrument 20B, to select the HART communication-compatible instrument 1C that is connected to the connecting slot with the slot number “3,” that is the nearest connecting slot.

Following this, the remote device information sending portion 24 of the HART I/O instrument 20A sends, as remote device information, the device information of the HART communication-compatible instrument 1C, selected by the selecting portion 23 to the HART communication-compatible instrument 1A.

Following this, the displaying portion 14 of the HART communication-compatible instrument 1A displays, on a display 14A′, the display information for the HART communication-compatible instrument 1C.

The result is that “16.0 mA,” which indicates the first variable value of the HART communication-compatible instrument 1C is displayed at 14a′ of the display 14A′ of the HART communication-compatible instrument 1A, “5.6.3,” which is the connection address information for the HART communication-compatible instrument 1C, and “VP-C,” which is the tag name for the HART communication-compatible instrument 1C, are displayed at 14b′, and “75.2%,” which indicates the second variable value of the HART communication-compatible instrument 1C is displayed at 14c′. The X that is displayed at the beginning of 14b′ is a mark indicating that the device information that is displayed currently on the display 14A′ is remote device information.

In this way, the process controlling system 100 of the alternate example, in addition to the effects described for the process controlling system 100 in the example, also makes it possible to display sequentially, on the display, information pertaining to other HART communication-compatible instruments that are connected to other HART I/O instruments 20B, in addition to information for HART communication-compatible instruments that are connected to the HART I/O instrument 20A, through inputting combinations of the “↓” key or the “↑” key and the “→” key or the “←” key in the HART communications-compatible instrument 1A.

1. An input/output instrument, to which a plurality of devices for sending and receiving a signal relating to a process are configured to be capable of being connected, the input/output instrument comprising:
an operating signal receiving portion that receives, from a first device that is one of the plurality of said devices, an operating signal corresponding to a specific operating instruction;
a selecting portion that selects, based on the operating signal that has been received by the operating signal receiving portion, any single second device, from among the devices connected to a local input/output instrument, other than the first device that is the source that sent the operating signal; and
a remote device information sending portion that sends as remote device information to the first device that was the source that sent the operating signal, information pertaining to the second device that was selected by the selecting portion.

2. The input/output instrument as set forth in claim 1, further comprising:
a plurality of connecting slots that connect the devices through communication cables,
wherein the selecting portion selects the second device through scanning the connecting slots in a direction that increases specific information or a direction that decreases specific information, in order to specify the connecting slot, with each operating signal that is received by the operating signal receiving portion.

3. The input/output apparatus comprising:
a plurality of the input/output instruments, to each of which a plurality of devices for sending and receiving a signal relating to a process are configured to be capable of being connected, the input/output instrument comprising:
an operating signal receiving portion that receives, from a first device that is one of the plurality of said devices, an operating signal corresponding to a specific operating instruction;
a selecting portion that selects, based on the operating signal that has been received by the operating signal receiving portion, any single second device, from among the devices connected to a local input/output instrument, other than the first device that is the source that sent the operating signal;
a remote device information sending portion that sends as remote device information to the first device that was the source that sent the operating signal, information pertaining to the second device that was selected by the selecting portion; and
a plurality of connecting slots that connect the devices through communication cables,
wherein the selecting portion selects the second device through scanning the connecting slots in a direction that increases specific information or a direction that decreases specific information, in order to specify the connecting slot, with each operating signal that is received by the operating signal receiving portion.
wherein the operating signal includes a first operating signal that directs the sequential selection of a connecting slot within a single input/output instrument and a second signal that directs the sequential selection of an input/output instrument within a single input/output apparatus, and
wherein the selecting portion,
upon reception of the first signal by the operating signal inputting portion, each time the first signal is received, scans the connecting slots in either the direction with which the specific information increases or the direction with which the specific information decreases, in order to specify the connecting slot to select the second device, and
upon reception of the second signal by the operating signal inputting portion, each time the second signal is received, scans the input/output instruments in either the direction with which the specific information increases or the direction with which the specific information decreases, in order to specify the input/output instrument to select the second device.

4. A system comprising:
a device that sends and receives signal relating to a process; and
an input/output instrument to which a plurality of devices are configured to be capable of being connected,
wherein the device comprises:
an operation inputting portion that inputs a specific operating instruction;
an operating signal transmitting portion that transmits, to the input/output instrument, an operating signal corresponding to the operating instruction inputted from the operation inputting portion;
a remote device information receiving portion that receives, from the input/output instrument, remote device information that is information pertaining to another device that is connected to the input/output instrument that has been selected based on the operating signal; and
a displaying portion that displays the remote device information that has been received from the remote device information receiving portion, and
wherein the input/output instrument comprises:
an operating signal receiving portion that receives the operating signal from a first device that is one of the plurality of said devices;
a selecting portion that selects, based on the operating signal that has been received by the operating signal receiving portion, any single second device, from among the devices connected to a local input/output instrument, other than the first device that is the source that sent the operating signal; and
a remote device information sending portion that sends as remote device information to the first device that was the source that sent the operating signal, information pertaining to the second device that was selected by the selecting portion.

5. The system as set forth in claim 4, wherein
the input/output instrument further comprises:
a plurality of connecting slots that connect the devices through communication cables, and
the selecting portion selects the second device through scanning the connecting slots in a direction that increases specific information or a direction that decreases specific information, in order to specify the connecting slot, with each operating signal that is received by the operating signal receiving portion.

6. The system as set forth in claim 5, further comprising:
an input/output apparatus that includes a plurality of said input/output instruments,
wherein the operating signal includes a first operating signal that directs the sequential selection of a connecting slot within a single input/output instrument and a second signal that directs the sequential selection of an input/output instrument within a single input/output apparatus, and
wherein the selecting portion,
upon reception of the first signal by the operating signal inputting portion, each time the first signal is received, scans the connecting slots in either the direction with which the specific information increases or the direction with which the specific information decreases, in order to specify the connecting slot to select the second device, and
upon reception of the second signal by the operating signal inputting portion, each time the second signal is received, scans the input/output instruments in either the direction with which the specific information increases or the direction with which the specific information decreases, in order to specify the input/output instrument to select the second device.

7. A device for sending and receiving a signal relating to a process, comprising:
an operation inputting portion that inputs a specific operating instruction;
an operating signal transmitting portion that transmits, to an input/output instrument to which a plurality of devices are configured to be capable of being connected, an operating signal corresponding to the operating instruction inputted from the operation inputting portion;
a remote device information receiving portion that receives, from the input/output instrument, remote device information that is information pertaining to another device that is connected to the input/output instrument that has been selected based on the operating signal; and
a displaying portion that displays the remote device information that has been received from the remote device information receiving portion.
